(19) United States
(12) Patent Application Publication
(10) Pub. No.: US 2012/0085723 A1
(43) Pub. Date: Apr. 12, 2012

(54) BOOM ELEMENT, TELESCOPIC BOOM AND CONSTRUCTION VEHICLE

(75) Inventor: Hans-Dieter Willim, Ulm-Unterweiler (DE)

(73) Assignee: Liebherr-Werk Ehingen GmbH, Ehingen (DE)

(21) Appl. No.: 13/267,996

(22) Filed: Oct. 7, 2011

(30) Foreign Application Priority Data
Oct. 8, 2010 (DE) 202010014103.6

(51) Int. Cl. B66C 23/04

(52) U.S. Cl. 212/350; 212/348

(57) ABSTRACT

The present invention relates to a boom element for a telescopic boom, particularly a telescopic shot or a telescopic boom base section, wherein the boom element has cupped corner pieces and lattice bars, and the cupped corner pieces are interconnected by means of the lattice bars, wherein the lattice bars are arranged in a framework, at a right angle with respect to the corner pieces, and/or at an angle different from a right angle, particularly at an acute or obtuse angle, with respect to the corner pieces, and the corner pieces and the lattice bars form a substantially box-shaped hollow structure.

The present invention relates to a boom clement for a telescopic boom, particularly a telescopic shot or a telescopic boom base section, to a telescopic boom, and to a construction vehicle.

In wind turbines, very high hub heights for the wind wheels have in the meantime become desirable, to achieve a wind power on the rotor blades that is as homogeneous as possible. Therefore, in the installation of wind turbines, the maximum achievable hub height represents a characteristic value for the required lifting devices, usually mobile cranes with telescopic booms.

Starting with the demand for very large boom systems with large boom lengths, the problem arose that conventional telescopic booms became excessively heavy. However, telescopable booms, in comparison to booms made of the usual lattice elements, have the advantage that they can be converted rapidly from a state for transport to a working state, and they require considerably less space the time of the installation. Another essential advantage is that, in the case of the lattice boom cranes that are usually used for the installation of the wind turbine, due to the large boom lengths, derrick booms with the appropriate derrick ballast are required to erect the boom.

Moreover, if a crane with lattice boom is to be moved in the rigged state to a construction site, i.e., if its location is to be changed, the overall center of gravity of the crane is excessively high. If the lattice boom could be telescoped, then it would not be necessary to set up the boom at a very steep angle, to achieve the required safety with regard to the danger of tipping. Indeed, telescoping could result in a lowering of the center of gravity, which is a great advantage with regard to the danger of tipping.

From DE 200 14 056 U1, a telescopic boom with telescopic shots is already known wherein the corner profiles of the telescopic shot are connected to each other by means of lattice bars in a framework arrangement, and connecting metal plates.

Moreover, from EP 0 754 646 A1, a multishot telescope system is known, in which the telescopable shots can be bolted by means of a bolting system for the purpose of blocking.

Therefore, the problem of the present invention is to further develop a boom element of the type mentioned in the introduction, particularly to the effect that, for the purpose of achieving as high as possible a lifting height, said boom element has, besides the required stability, a reasonably practicable weight.

This problem is solved according to the invention by a boom element for a telescopic boom having the characteristics of Claim 1. Accordingly, it is provided that the boom element has cupped corner pieces and lattice bars, and the cupped corner pieces are interconnected by means of the lattice bars, wherein the lattice bars are arranged in a framework, at a right angle with respect to the corner pieces, and/or at an angle different from a right angle, particularly at an acute or obtuse angle, with respect to the corner pieces, and the corner pieces and the lattice bars form a substantially box-shaped hollow structure.

In particular, the boom element can be a telescopic shot or a telescopic boom base section, that is, the part of the telescopic boom in which the additional boom elements, namely the additional telescopic shots, are held in a manner that allows telescoping.

Due to the connection of the corner pieces, which in each case form the outer edges of the box-shaped hollow structure, to the lattice bars, a stable structure that is capable of bearing a load, and at the same time relatively lightweight, can be produced advantageously. High or large lifting heights can thus be achieved easily, without at the same time having to accept an impracticable weight increase.

It is conceivable in principle that, besides the lattice bars connecting the corner pieces, connecting metal plates are used, so that the box-shaped hollow structure, at least in some sections, has closed outer walls, and not only the lattice bars in a framework arrangement on the side surfaces of the hollow structure. However, this is not absolutely required, although it may be desirable in order to cover components, for example, actuation elements of the telescope cylinder, in the retracted and/or extended state.

Moreover, it is possible to provide that the corner pieces have an edged and/or bent design and/or are manufactured from pipe sections and/or extruded sections. By using semifinished products, it is advantageously possible to lower the initial cost, while at the same time guaranteeing the quality of the components used.

Furthermore, the corner pieces may present and/or form connecting pieces, wherein the lattice bars can be connected and/or joined to the connection pieces.

Moreover, it is conceivable that within the interior of the corner pieces one or more bearing seats are arranged, by means of which an additional boom element which is guided in the boom element can be guided and supported.

In an additional advantageous embodiment, the boom element has an extension opening, out of which the additional boom element(s) located in the boom element can be extended, wherein, at the lower edge of the boom element, at least one bearing element is arranged, by means of which an additional boom element located in the boom element can be braced, and/or, in the area of the extension opening, at least one abutment element is provided, by means of which the maximum extension movement of the additional boom element located in the boom element can be limited.

Moreover, it is conceivable that, between at least one bearing seat and at least one bearing element, at least one spacer block is provided or arranged, by means of which the bearing seat and the bearing element can be pressed directly and/or indirectly, [and that] particularly at the time of the complete extension of an additional boom element located in the boom element, the bearing seat and the bearing element are pressed against each other, wherein it is preferred that the spacer block is reinforced with at least one reinforcement core, particularly a steel core. By reinforcing with the reinforcement core, the stability of the construction can be improved advantageously.

Moreover, it is possible to provide that at least one component of a bolting system is arranged in at least one of the corner pieces, wherein by means of said bolting system an additional boom element located in the boom element can be bolted to be secured to the boom element, and wherein the component of the bolting system is and/or comprises at least one bolt receiver and/or at least one bolt guide, in which the at least: one bolt is guided and movable, wherein the bolt receiver can preferably have a reinforced bolting metal plate which is inserted and/or engaged in the corner piece, and wherein, moreover, at least one bolting system is arranged in three or four corner pieces.

In addition, it is possible that the corner pieces which arc in a low position in the installed state protrude over the end cross section of the hollow structure, particularly over the extension opening. As a result, the attachment and positioning of the next corner piece during the installation of the telescopic boom can be simplified.

The present invention further relates to a telescopic boom having the characteristics of Claim 9. Accordingly, a telescopic boom is provided with at least one boom element according to one of Claims 1-9.

The present invention further relates to a construction vehicle having the characteristics of Claim 10. Accordingly, it is provided that a construction vehicle, particularly a mobile crane with telescopic boom, is provided with at least one boom element according to one of Claims 1-8 or with a telescopic boom according to Claim 9.

Additional details and advantages of the invention are explained in further detail below in reference to an embodiment example represented in the drawing.

The figures show:

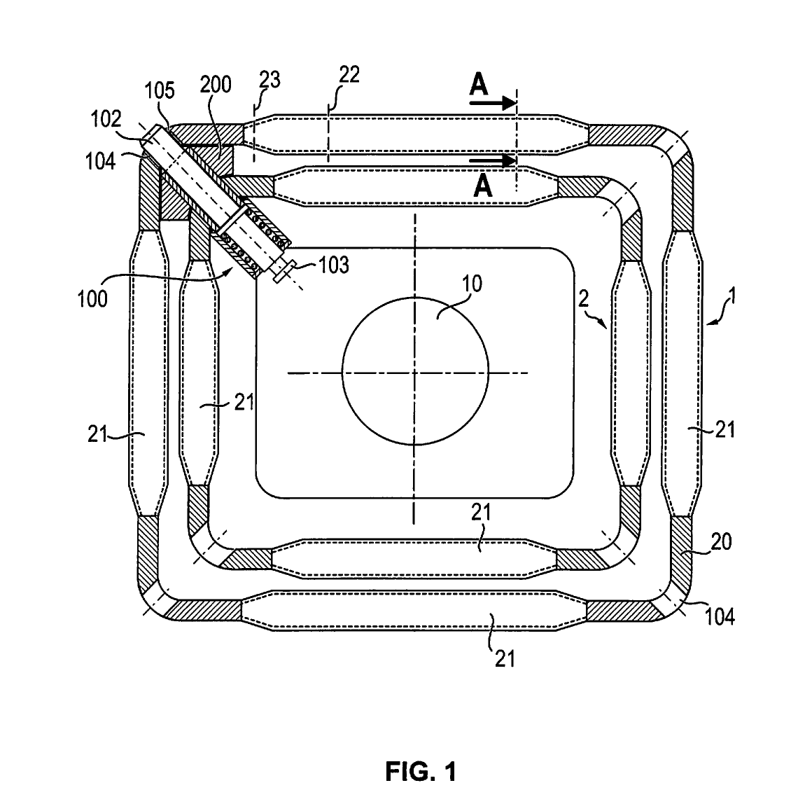

FIG. 1: a diagrammatic front view of a telescopic boom;

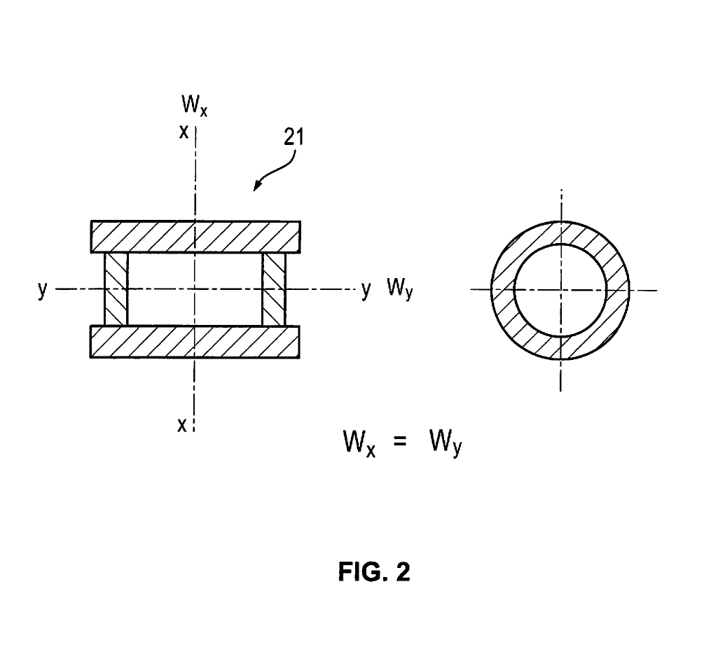

FIG. 2: a cross section A-A through the telescopic boom shown in FIG. 1;

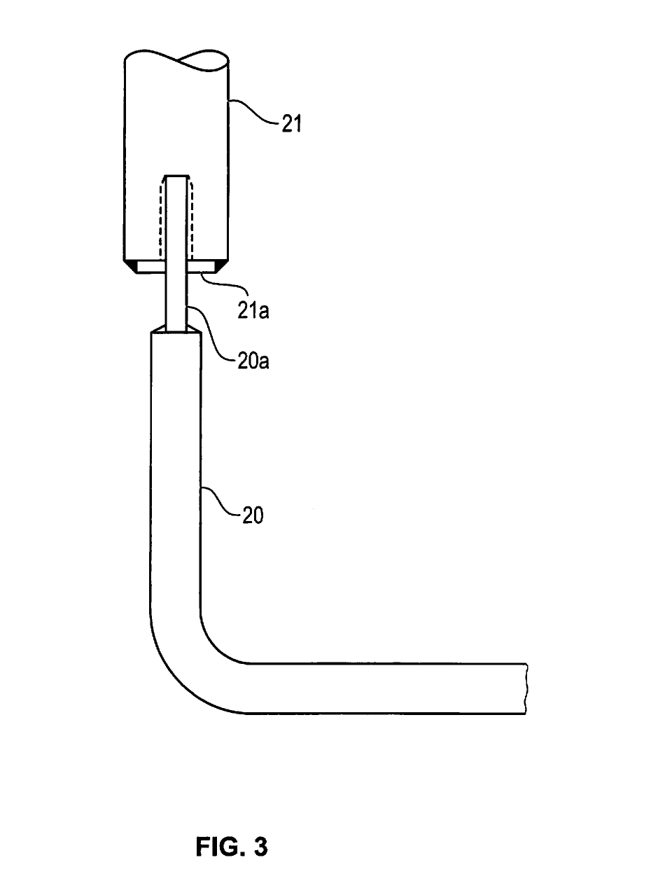

FIG. 3: a diagrammatic representation of a first embodiment of the connection of a corner piece to a lattice bar;

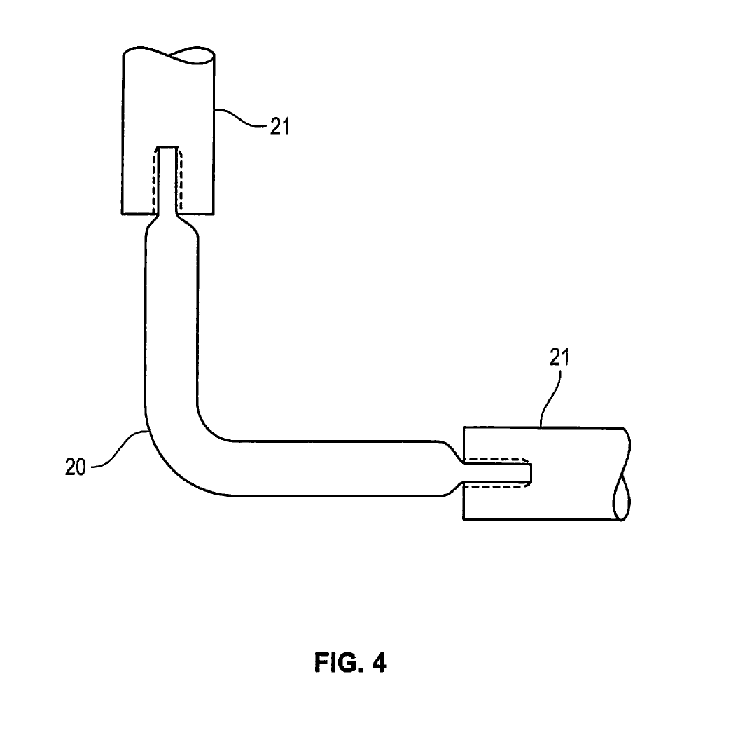

FIG. 4: a diagrammatic representation of a second embodiment of the connection of a corner piece to a lattice bar;

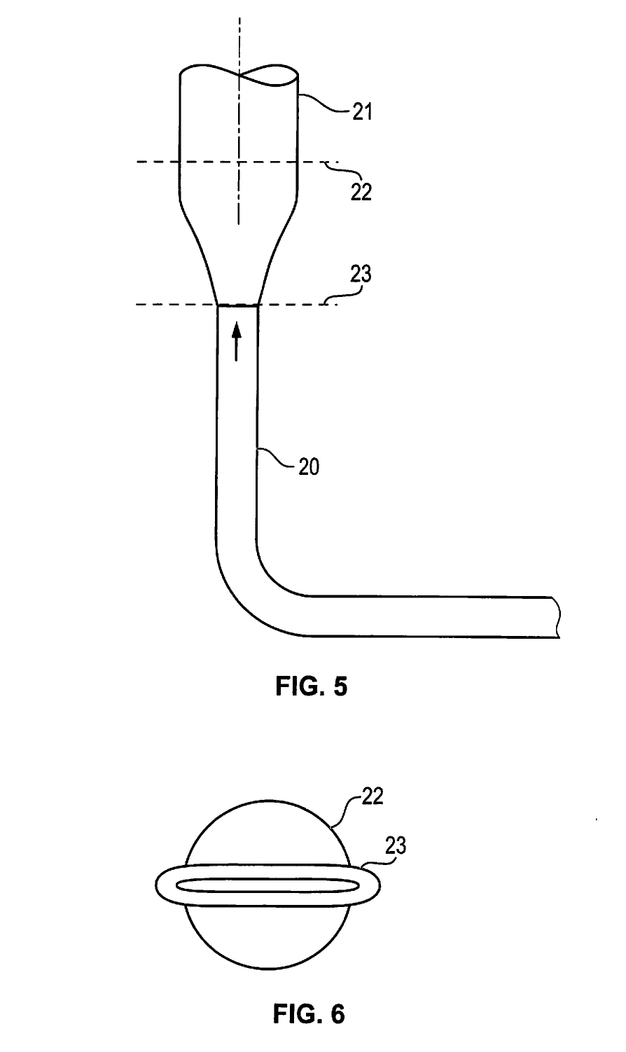

FIG. 5: a diagrammatic representation of a third embodiment of the connection of a corner piece to a lattice bar;

FIG. 6: a schematic detail representation of the embodiment of the connection of a corner piece to a lattice bar, shown in FIG. 5;

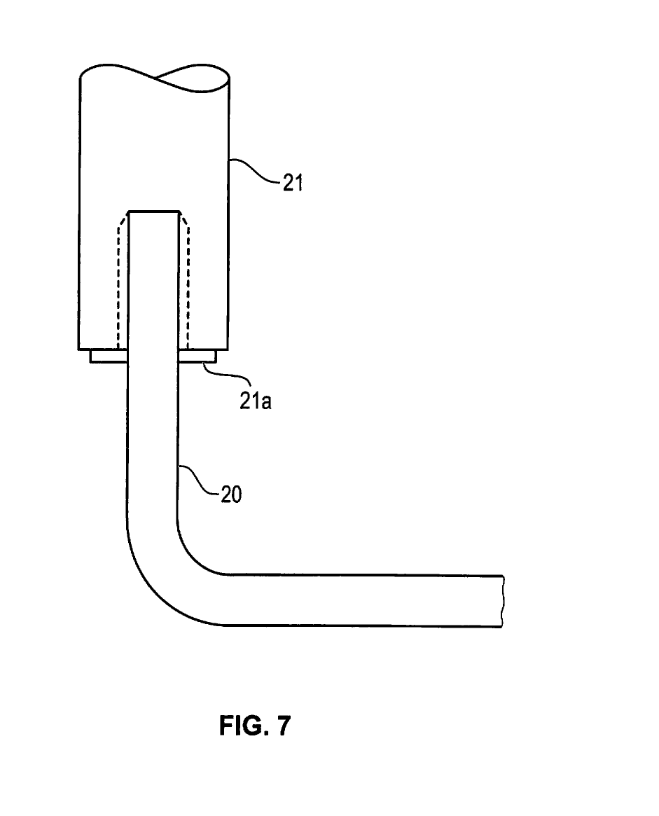

FIG. 7: a diagrammatic representation of a fourth embodiment of the connection of a corner piece to a lattice bar;

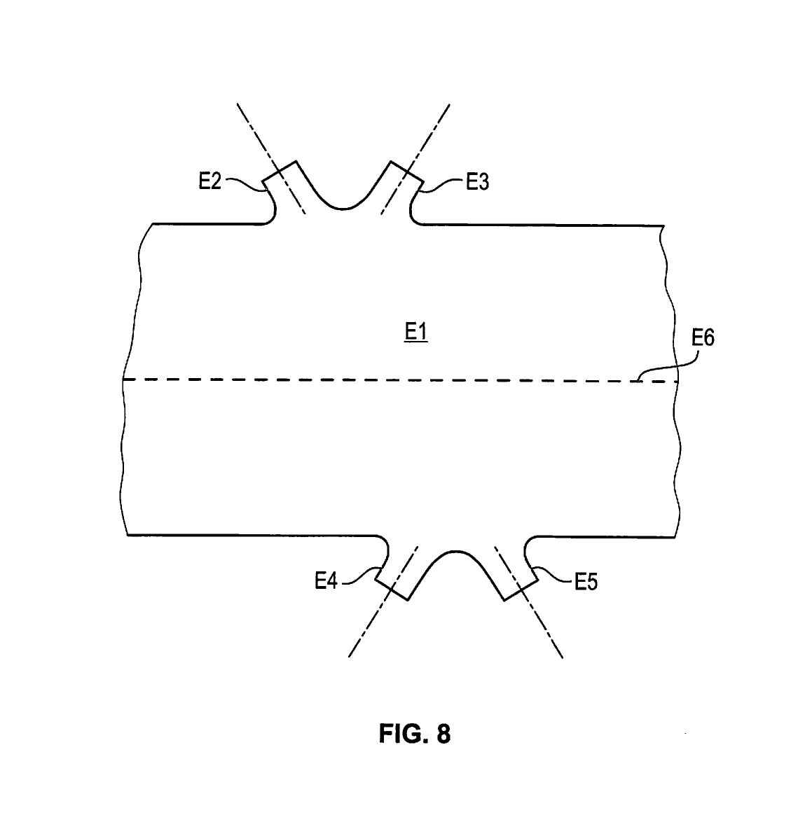

FIG. 8: a diagrammatic representation of a possible embodiment of the corner piece;

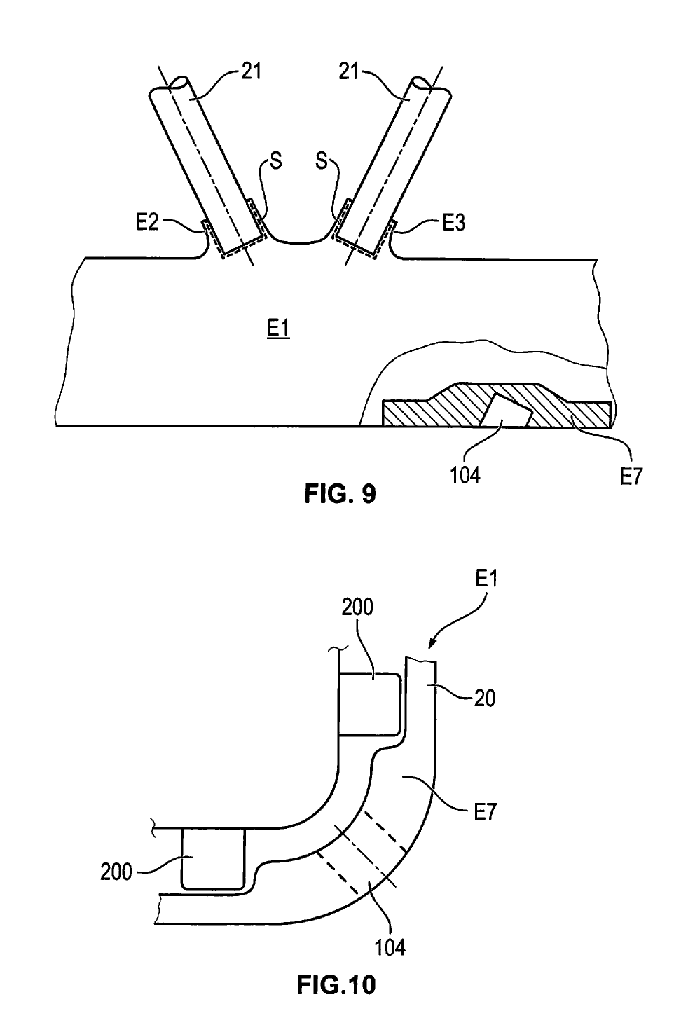

FIG. 9: an additional diagrammatic representation of the embodiment of the corner piece shown in FIG. 8;

FIG. 10: an additional diagrammatic representation of the embodiment of the corner piece shown in FIGS. 8 and 9;

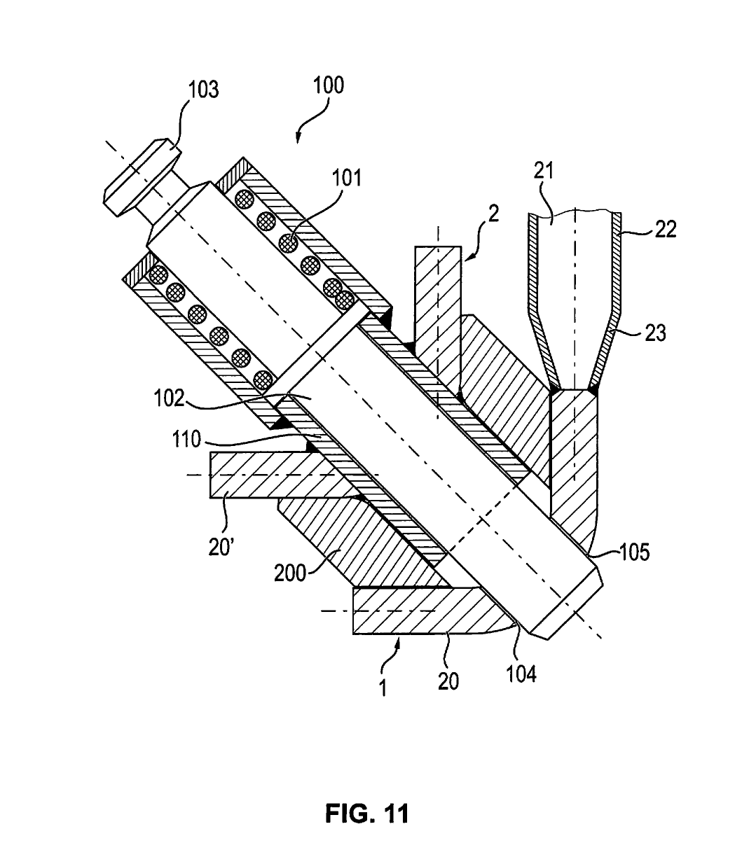

FIG. 11: a diagrammatic detail representation of a bolting system;

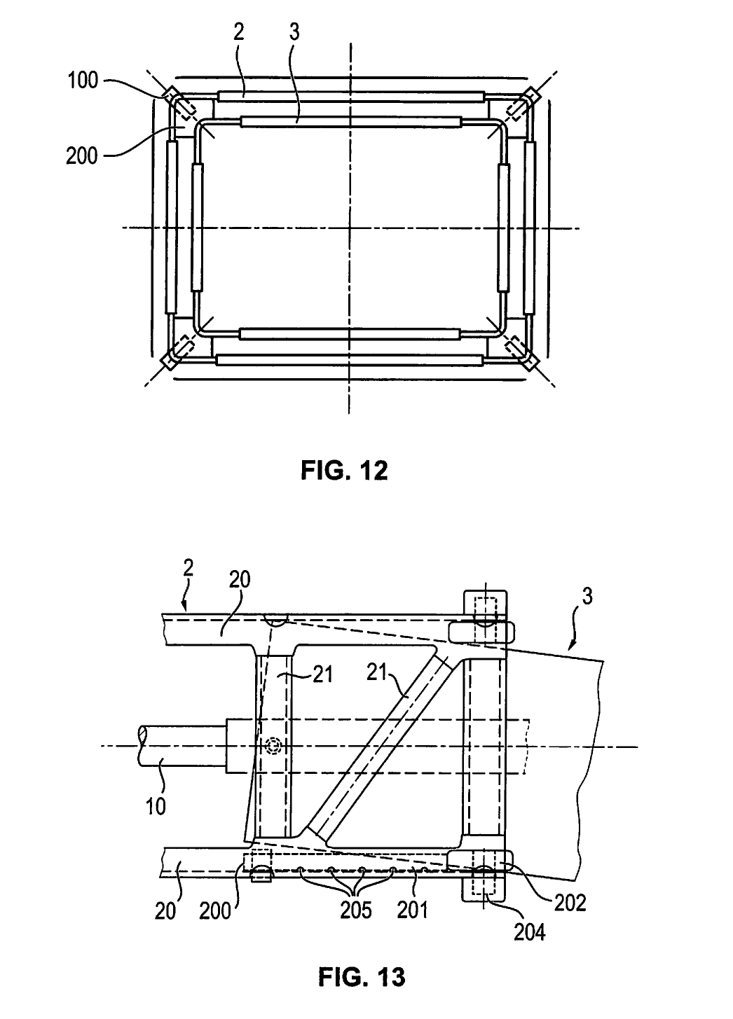

FIG. 12: a diagrammatic front view of the telescopic boom;

FIG. 13: a diagrammatic side view of the telescopic boom;

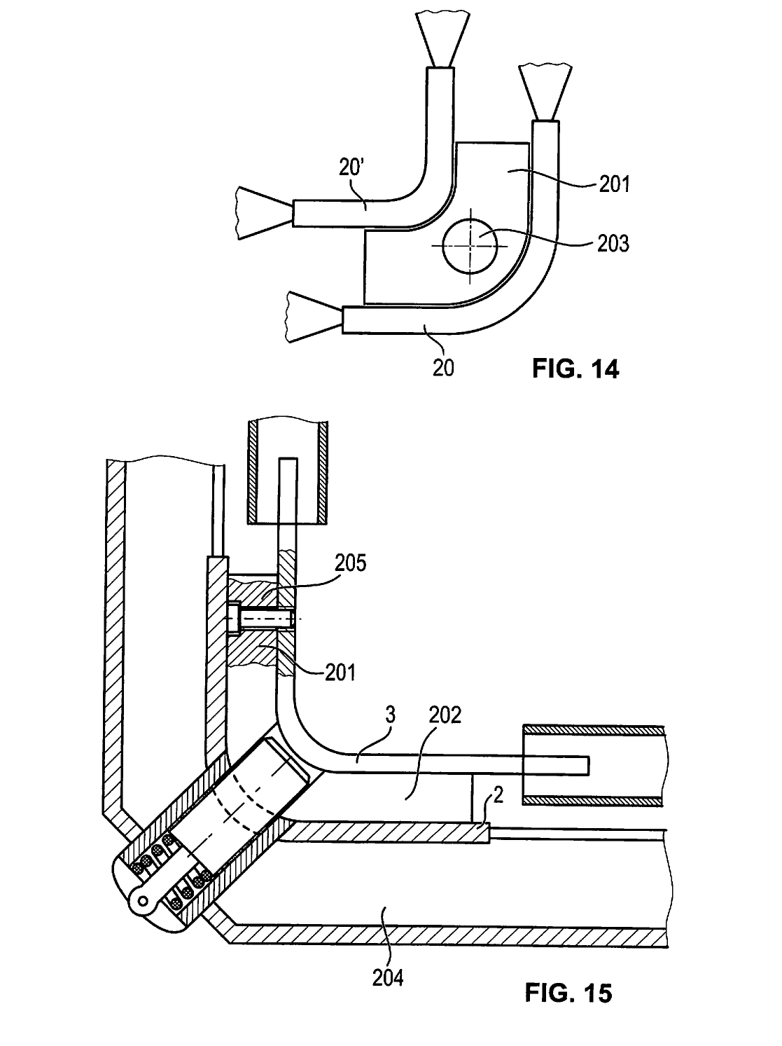

FIG. 14: a diagrammatic detail representation of the front bearing position of the telescopic boom;

FIG. 15: a diagrammatic cross-sectional representation through the front bearing position of the telescopic boom;

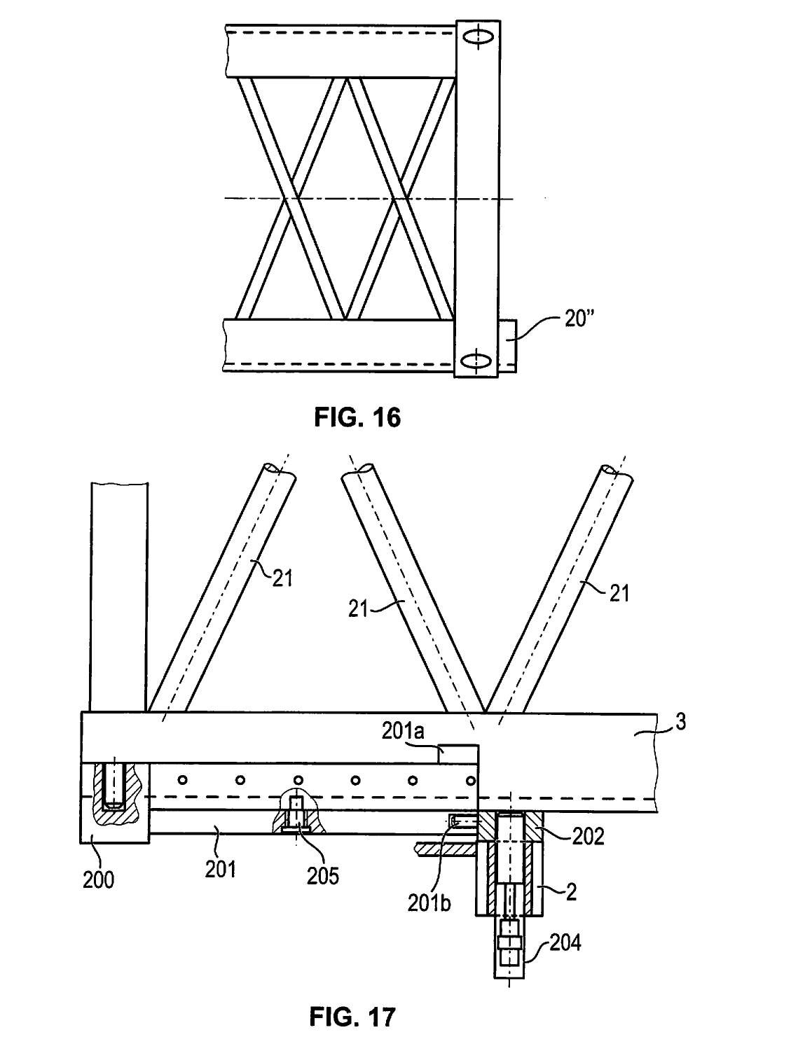

FIG. 16: a diagrammatic side view of an additional embodiment of the telescopic boom;

FIG. 17: a diagrammatic side view of an additional embodiment of the telescopic boom;

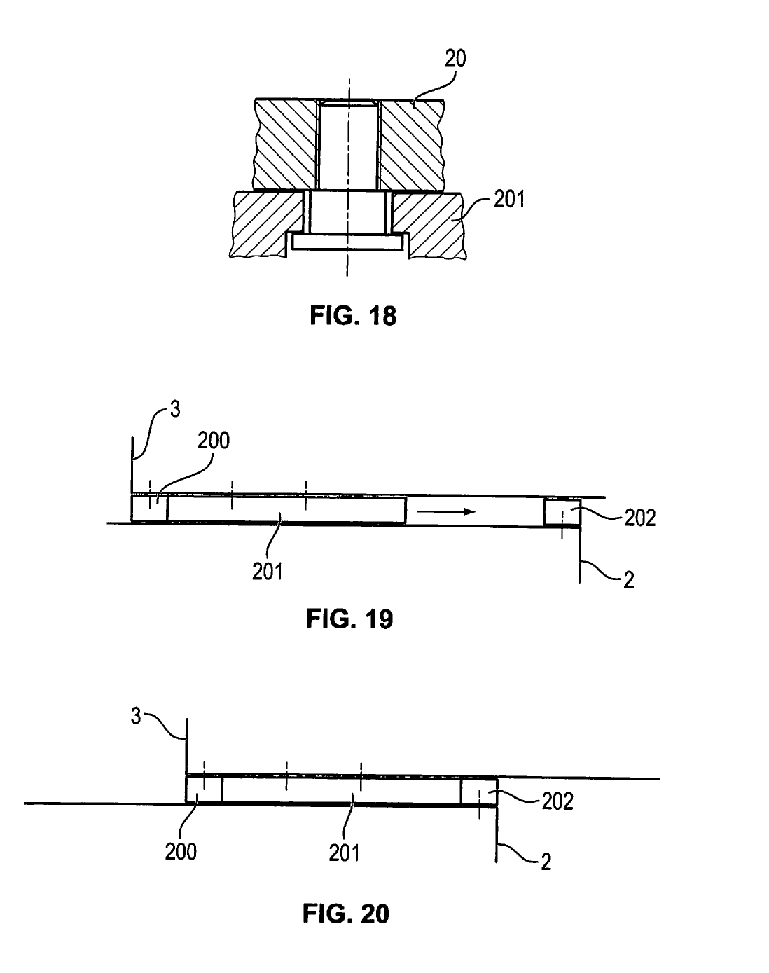

FIG. 18: a diagrammatic detail view of the embodiment of the telescopic boom according to FIG. 17;

FIG. 19: a first schematic diagram of the extension process of the telescopic boom;

FIG. 20: a second schematic diagram of the extension process of the telescopic boom;

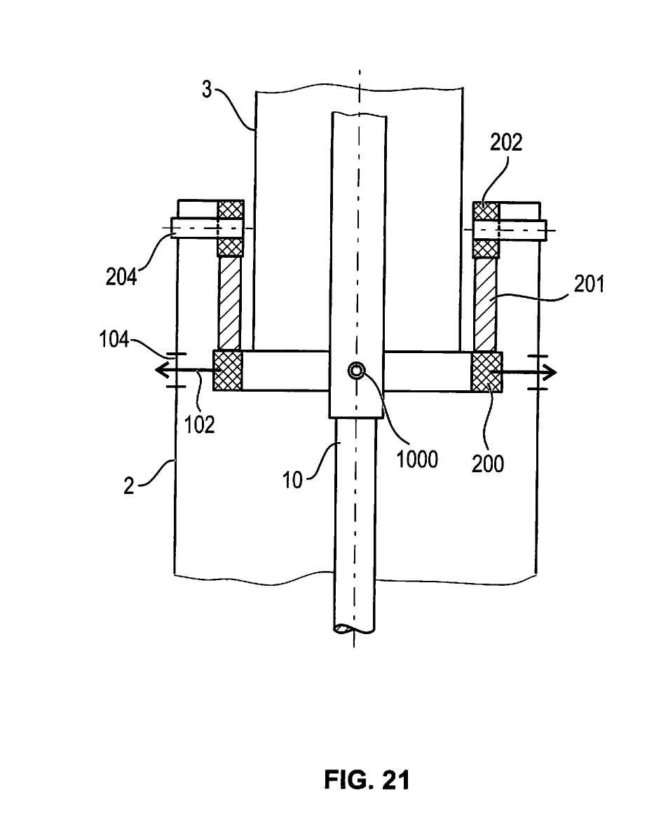

FIG. 21: a third schematic diagram of the extension process of the telescopic boom;

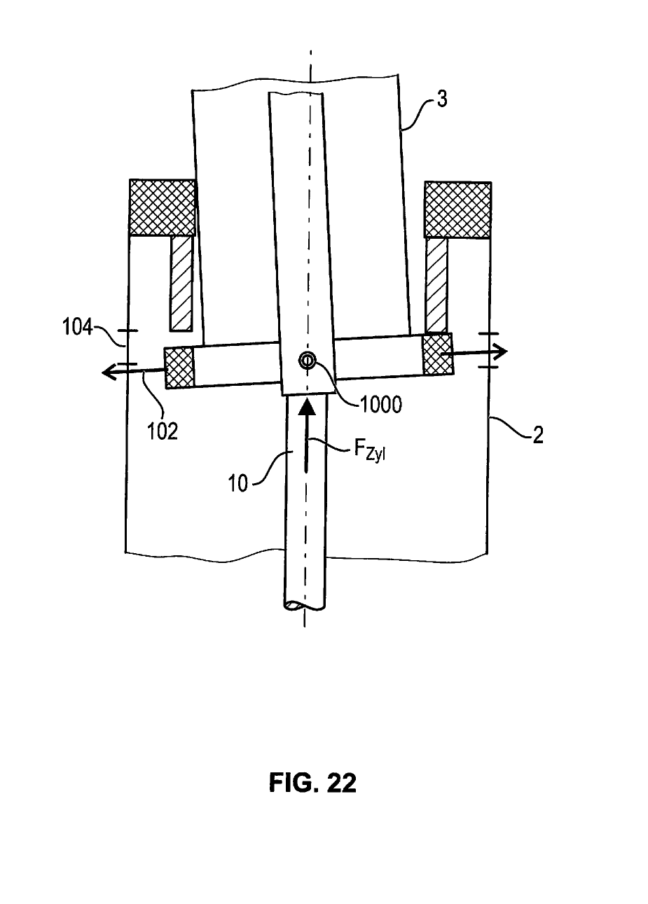

FIG. 22: a fourth schematic diagram of the extension process of the telescopic boom;

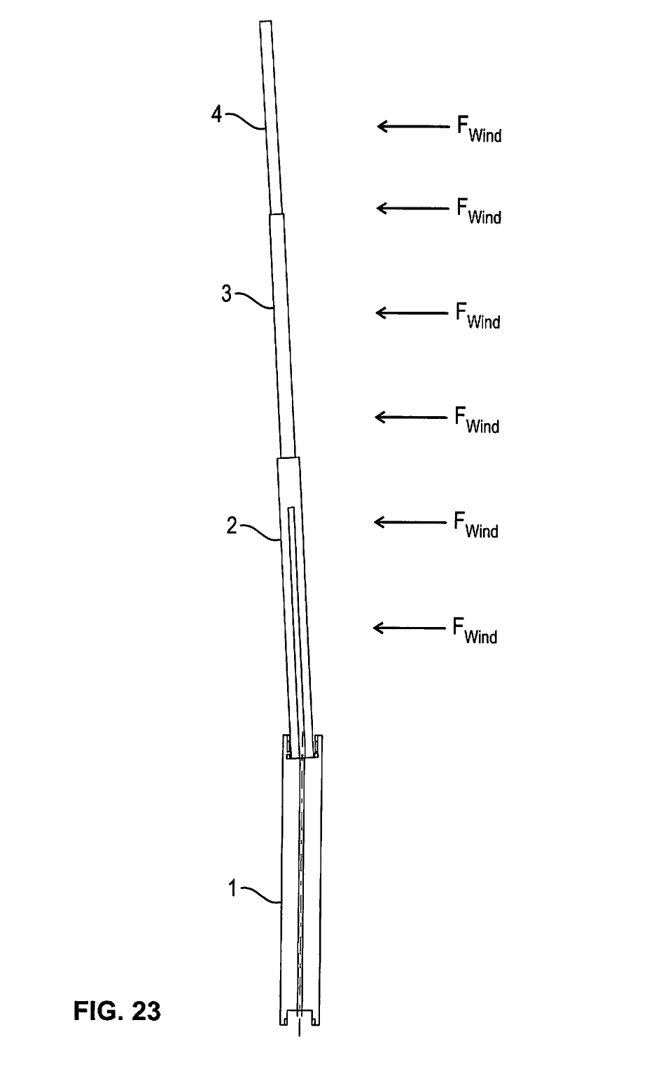

FIG. 23: a diagrammatic representation of the telescopic boom under exposure to wind forces;

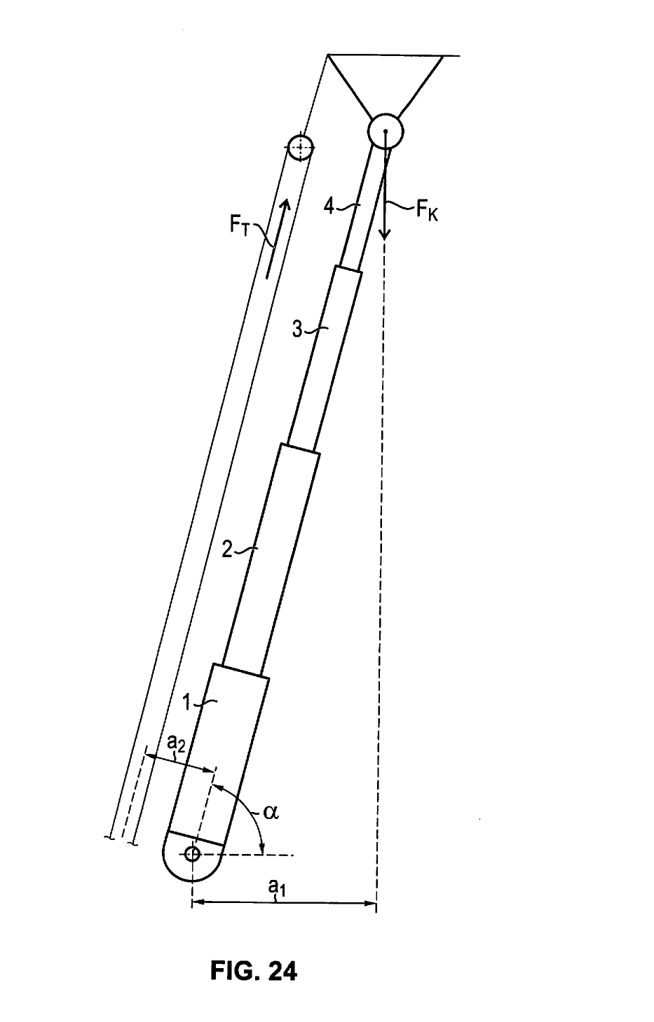

FIG. 24: a diagrammatic representation of the telescopic boom in the extended state;

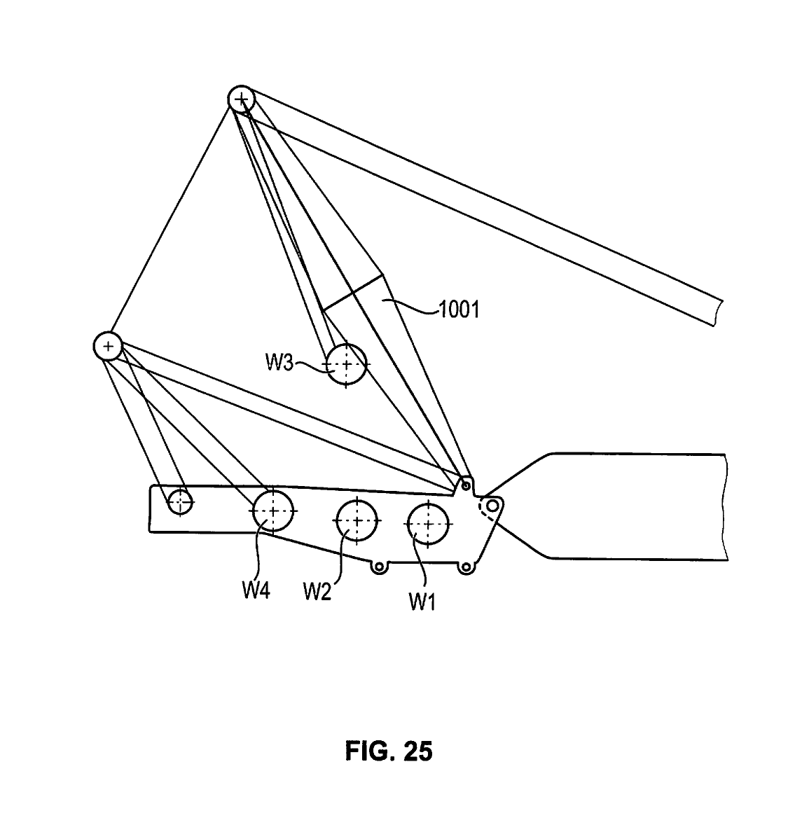

FIG. 25: a diagrammatic representation of a derrick boom;

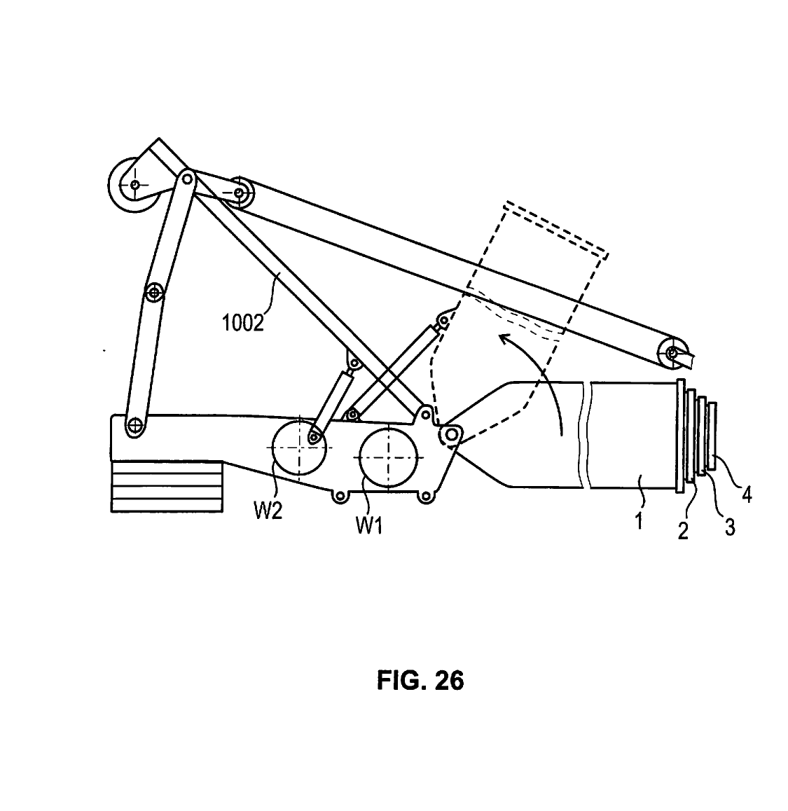

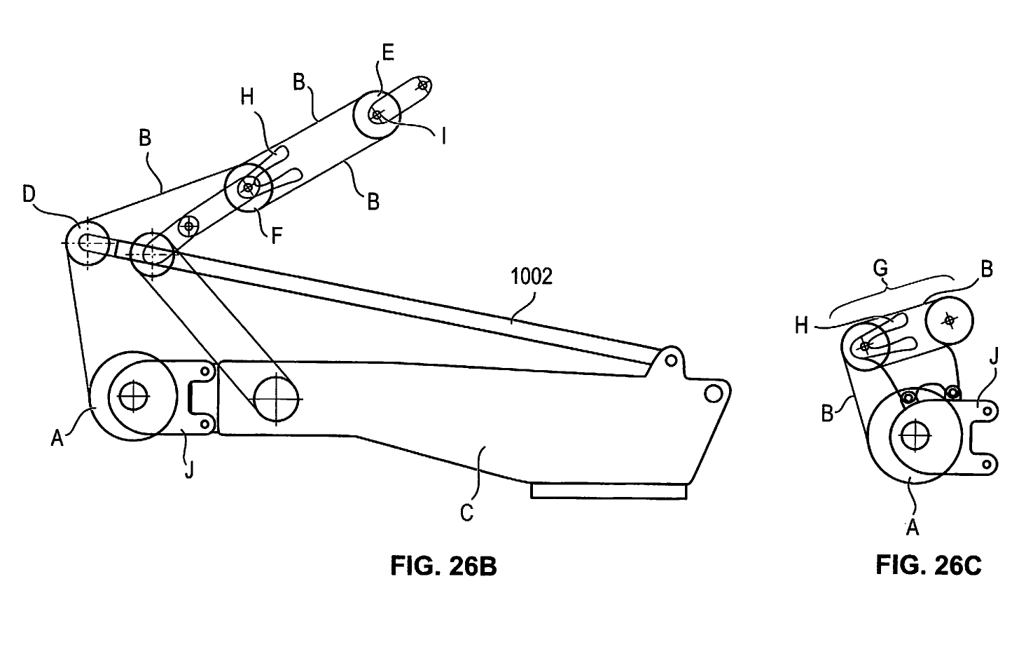

FIG. 26: a diagrammatic representation of the telescopic boom;

FIG. b, c: a diagrammatic representation of an alternative design of the telescopic boom according to FIG. 26;

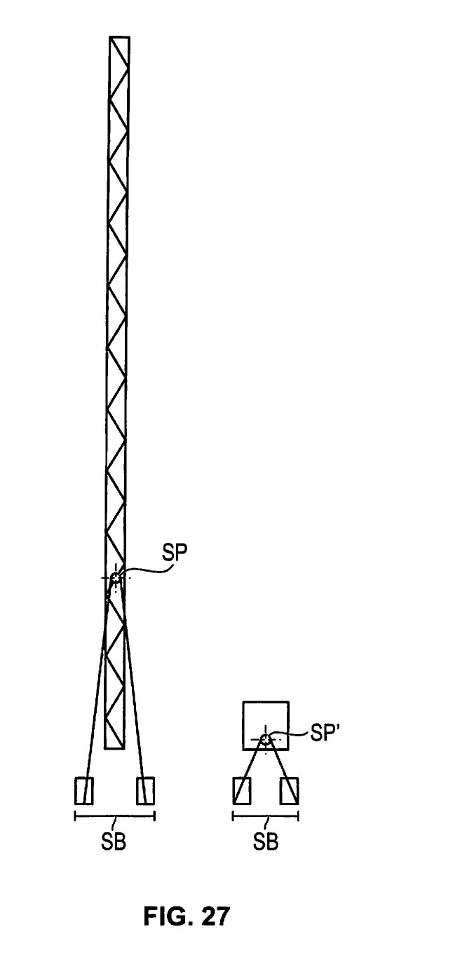

FIG. 27: a diagrammatic representation of the centers of gravity of a lattice crane and of a telescopable lattice crane according to the invention;

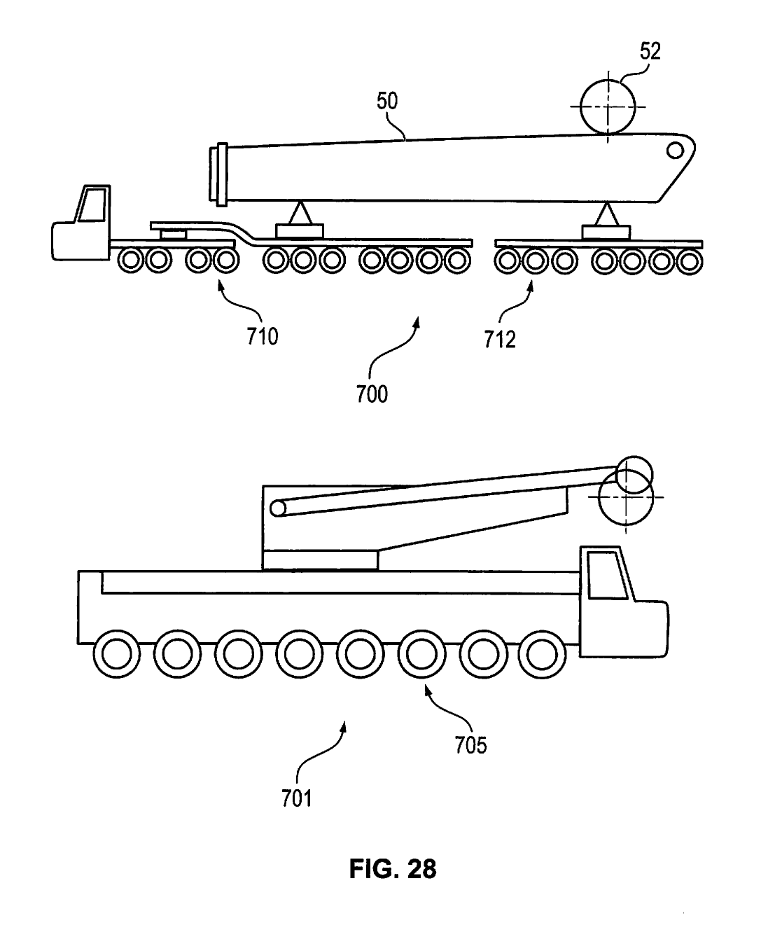

FIG. 28: a diagrammatic representation of the segmentation of the transport units of the boom or crane for travel over terrain; and

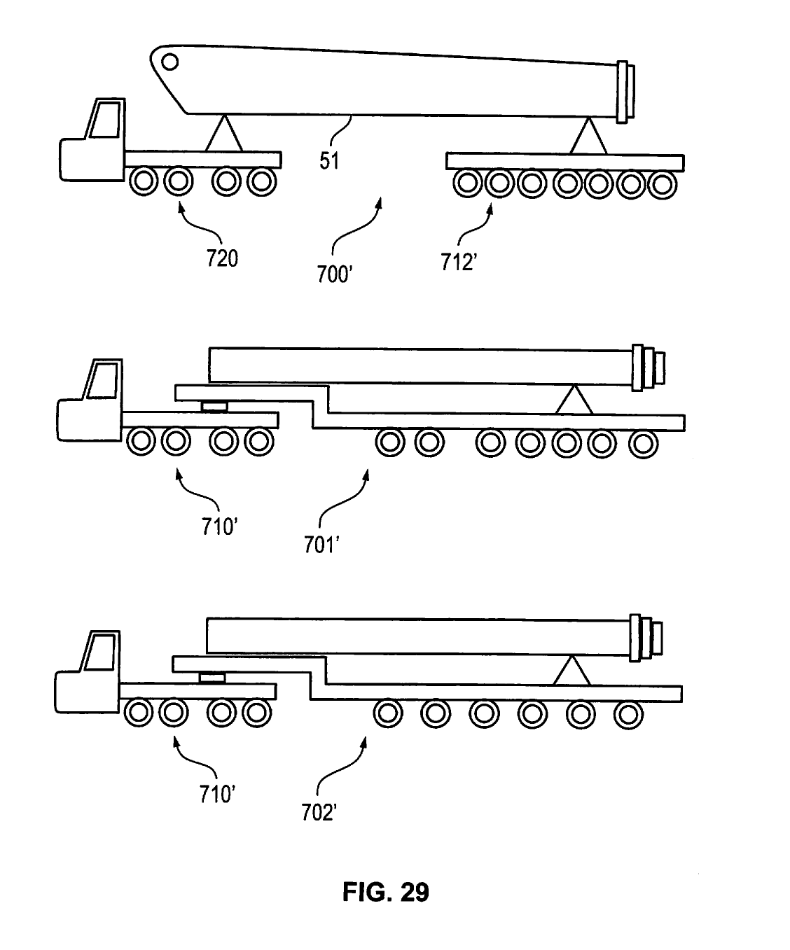

FIG. 29: a diagrammatic representation of the segmentation of the transport units of the boom or crane for travel over roads.

FIG. 1 shows a diagrammatic front view of a portion of the telescopic boom according to the invention, wherein two telescopic shots 1 and 2 are represented. As can be seen in FIG. 1, cupped corner pieces 20 are used in each telescopic shot 1, 2, 3, and 4.

The corner pieces 20 can be manufactured as edged, bent pieces from pipe sections, or even as an extruded section. The corner pieces 20 are connected via lattice bars 21 which, if arranged at a right angle with respect to the corner pieces 20, are referred to as unstressed pieces, and/or if arranged at another angle with respect to the corner pieces 20, as diagonals.

Each lattice bar 21 can also be manufactured from a welded construction made of four metal plates, as represented in FIG. 2. FIG. 2 shows the cross section A-A indicated in FIG. 1. The resistance moment W, about the X-axis x and the resistance moment W_{y} [about] the Y-axis y are of equal magnitude, and correspond to that of a circular pipe cross section. Thus, a tubular lattice bar 21 is simulated, and the “flat” construction form is achieved nonetheless. The wind strengths are optimized with regard to potential buckling.

Each telescopic shot 1, 2, 3 and 4 (see also FIG. 23) has recesses 104 in the cupped corner pieces 20, recesses in which the inner telescopic shot 2, 3 and 4 can be bolted. The bolting system hears the reference 100 in FIG. 1. To simplify the pairing of bolts 102 and recess 104, an elongated hole 105 can be provided on the side. Thus, the elongated hole is oriented perpendicularly to the longitudinal axis of the corner piece 20, which enables rotation. It is essential that the orientation in the longitudinal axis of the corner pieces 20 occurs with high precision. As explained in further detail below in reference to FIGS. 11 and 12, the bolting system can be actuated by means of the actuation element 103.

To be able to telescope the telescopic shots 1, 2, a centrally arranged telescope cylinder 10 is placed, by means of which the telescopic shot 2 shown in FIG. 1 can be telescoped out of the telescopic shot 1, and also retracted again.

Bearing seats 200 are provided furthermore between each enclosing and directly adjacent telescopic shot. Since the bearing seats 200 determine or define the separation between the telescopic shots, the welded construction of the lattice bars 21 can have a larger cross section 22 in some areas compared to other points 23, where the points 23 are particularly the connections, or in the area of the connections to the corner pieces 20. As a result, the force flow from the corner piece 20 into the lattice bar 21 is designed optimally, that is free of notches.

However, for cost reasons, the lattice bar 21 is generally produced in a known manner from a pipe having a circular cross section. In that case, however, the available construction space between the adjacent telescopic shots is not used optimally. The tight space conditions can be seen in FIG. 1.

Additional embodiments are represented in FIGS. 3-7.

FIG. 3 shows a possible design of the connection of a corner piece 20 to a lattice bar 21, wherein the lattice bar 21 is a slit pipe. The slit pipe here also has a cover metal plate 21a. The corner piece 20 is a normally edged metal plate which, to reduce the need for cutting, has no connection points of its own, in particular connections E2, E3, E4 and E5, as shown in FIGS. 8 and 9. For this reason, the connecting metal plates 20a are required, which are welded to the corner piece 20, and introduced into an end-side slit of the lattice bar, and attached there.

FIG. 4 shows an embodiment which is similar to the embodiment shown in FIG. 3, wherein, however, the corner piece 20 is produced from a profiled extruded section. This results in the advantage that different metal plate thicknesses can be implemented.

The solution shown in FIGS. 5 and 6 is designed in such a manner that the connecting metal plate 20a can be omitted. Here, the lattice bar 21 is pressed at its end(s), as shown in detail in FIG. 6. This results in a flat cross section to which the corner piece 20 can be welded directly.

FIG. 7 shows a connection of the corner piece 20 and the lattice bar 21, wherein the corner piece 20 is welded directly into the slit lattice bar 21. Here, a cover metal plate 21a can also be used.

If the corner piece 20 is made from an edged metal plate El., as shown in FIGS. 8 and 9, then it can be provided already at the time of the burning out of the mold with the connections E2, E3, E4 and E5 for the lattice bars 21 that form the diagonals and possibly unstressed pieces. After the burn out, the metal plate E1 is edged at the provided point E6. After the edging, the connection between the lattice bars 21 and the connections E2, E3, E4 and E5 is established by means of welding seams S.

If the bolting points 104 or recesses 104 (see, for example, FIG. 1) have to be reinforced, this can also be taken into account already at the time of the burn out. A reinforced bolting metal plate E7 can be used, as shown in FIG. 9. The bolting metal plate E7 could also be a cast part.

If the reinforcement is present, then, for the purpose of the installation, the bearing seat 200 has to be recessed accordingly, or even consist of two portions, as shown in FIG. 10.

FIG. 11 shows a diagrammatic representation of the bolting system 100. The bolting system 100 has a bolt 102 which is spring loaded with a spring 101. The bolt has an actuation element 103. A guide and holding pipe 110 is welded in the corner piece 20′ located in the interior, which can be the corner piece 20′ of the telescopic shot 2, see FIG. 1.

The guide and holding pipe 110 here fulfills substantially two functions. On the one hand, it positions the bearing seat 200 and, on the other hand, it guides the bolt 102 of the bolting system 100 with great precision. The transmitted forces are transmitted further by the guide and holding pipe 110 into the corner piece of the telescopic shot 2, and thus into the corner pieces 20′. The bolt 102 is pulled at the actuation unit 103, and disengaged from the corner piece 20. Now, the telescope cylinder 10 can move the telescopic shot located in the interior, and engage it at another recess 104 in the corner piece 20. In contrast to the state of the art, it is now provided advantageously that several bolt systems 100 are provided, particularly four bolting systems for each telescopic shot, that is, one bolting system 100 in each one of the corner pieces 20, and this advantageously for each bolting point. Advantageously, each pair of telescopic boom elements here has at least two bolting points, namely a first bolting point for the retracted position, and a second bolting point for the extended position.

Advantageously, the bolting systems 100 are located in a plane which extends perpendicularly to the longitudinal axis of the telescopic shot, and, with respect to their bolt axis orientation, they are oriented in the bisecting line between the legs of the corner piece 20.

FIG. 12 shows two telescopic shots inside each other, for example, telescopic shot 2 and 3. As shown further in FIG. 13, the telescope cylinder 10 is connected to the telescopic shot 3, and it extends the latter outwards, after the detachment of the connection points, with the enclosing telescopic shot 2. As a result, the separation between the front bearing point 202 and rear bearing point 200 becomes smaller, and the bearing clearance allows the telescopic shot 3 to tilt further. The bearing seats 200 that serve as rear bearing points 200 have already been described in greater detail above. The rear bearing point 200 is connected furthermore to a spacer block 201. The spacer block 201 could also be connected to the front bearing point 202, or also only to the corner piece 20 at the provided point. For stability purposes, the spacer block 201 can have a steel core 203, as shown in FIG. 14.

FIG. 15 shows the connection of the bearing point to the corner pieces in different cross sections. The bolt 204 closed by the compression spring serves as abutment, and it holds the bearing seat 202 in position. The figure also shows a cut free spacer block with a guide screw. The hydraulically openable bolt 204 is needed to make it possible to take out the inner telescopic shot.

Additional holding devices 205, for example, guide screws 205 according to FIG. 15, can be provided. For this purpose, guide screws are used that function primarily to keep the spacer blocks 201 in position, while not deflecting the forces occurring at the time of the erection of the telescopic shots in the corner pieces 20.

The front bearing point 202 is connected to the enclosing telescopic shot 2. The connection can occur via the stable abutment bolt 204. The latter absorbs the forces in the extension direction of the telescopic shots.

As shown in FIG. 16, the lower corner pieces 20″ can be brought slightly forward. In this way, the attachment and positioning of the next corner piece during the installation of the telescopic boom is simplified.

In addition, it can be helpful and advantageous to use additional devices for precise positioning. As can be seen in FIG. 17, such devices can be, for example, an abutment 201 a which, when the final position of the spacer block 201 has been reached, brings the spacer block 201 in a defined position, that is it forces the spacer block 201 into a position. In addition, centering pins 201b can be provided, which guide the front bearing point 202 with the spacer block 201 into a defined position. FIG. 18 shows a corresponding additional detail view.

A further illustration of the extension process of the telescopic shot 3 out of the telescopic shot 2 is shown in FIGS. 19 and 20. At the beginning of the extension process, the bearing seat 200 of the telescopic shot 3 moves the spacer block 201 in the direction of the front bearing point 202. To complete the extension process, the spacer block 201 is pressed against the front bearing point 202.

As shown again in detail in FIGS. 21 and 22, the telescope cylinder 10 extends the telescopic shot 3 over the connection point 1000. The telescopic shot 3 is mounted on the side to the front bearing points 202 and the rear bearing points 200. Due to the clearance in the bearing points, the longitudinal axis of the telescopic shot 3 is tilted towards the longitudinal axis of the telescopic slim 2. Consequently, the bolts 102 of the bolting system 100 cannot be paired with the recesses 104 of the telescopic shots. If the rear bearing point 200 abuts via the spacer block 201 against the front bearing point 202, then the force F_{zyl} in the telescope cylinder 10 increases. As a result, a torque is generated about the connection that was established first between the rear bearing point 200 via the spacer block 201, and the front bearing point 202, and the other bolting points is brought into position. As a result, it becomes possible to pair the bolts 102 with the recesses 104. It should be taken into consideration that disturbances, for example, wind forces F_{Wind}, also have to be overcome (see FIG. 23).

Due to the narrow tolerances of the recesses 104 with respect to the bolts 102, no connection analogous to a telescopic boom is established; rather, a connection analogous to a lattice boom is established, that is, a stable compression member forms as a boom.

To remove load from all the bearing points, the boom can or is set at a steep angle. Here, setting angles of more than 80° with respect to the horizontal are used. An additional criterion is torque compensation during telescoping. FIG. 24 here shows the circumstances. If the telescopable lattice boom is telescoped, two essential parameters act on the boom, namely the weight of the load and/or hook block F_{K} with the separation a1, and the tensile force F_{T} out of the luffing block with the multiple reeving strands, which all have to be pulled off the winch, with the separation a2. The luffing angle α is chosen in such a manner that the two resulting torques compensate each other approximately. This also results in the removal of load from the bearing points.

Besides the rapid establishment: of the working capability, the small transport volume to the construction site should be emphasized as a special advantage. One great advantage of the derrick boom 1001 is the better angle at the time of the erection of the retracted telescoped boom, see FIG. 25. The arrangement of the winches W1, W2, W3 and W4 is also included here in the drawing.

FIG. 26 shows the erection of a telescopic boom consisting of the telescopic boom base section 1 and the telescopic shots 2, 3, 4, according to the invention. Because the boom is erected in the retracted telescoped state, no derrick boom is needed. A stay rack 1002 is sufficient. Once the telescopic boom is erected, then the telescoping of the respective telescopic shots starts, in the known manner. Here, the luffing stranding must obviously be paid out synchronously, in order not to substantially change the luffing angle of the telescopic boom.

FIG. 26b shows the stay rack 1002, which here has no winch. The winch A for pulling in the luffing stranding B of the main boom is bolted to the upper carriage frame C. The stay rack 1002 has at its end only one deflection roller D which guides the luffing stranding B to the stay rack. The stay rack can then be pulled together, so that the tipper block E is paired with the lower block F to form a unit G (FIG. 26c). In FIG. 26, this is indicated by means of the fork H and the extended axis 1 at the upper block. Subsequently, the unit can be connected to an auxiliary crane. The unit is then braced by the stay rack. 1002, and bolted again at the recess to the bolted on winch frame J (see FIG. 26c). In this way, a transport unit with optimum weight is formed, which has no effect on the upper carriage or the stay rack in terms of weight and dimension.

it remains to be mentioned that the telescopic boom according to the invention is not provided for operation with a luffing cylinder, It is always operated with a stay rack or derrick boom and luffing stranding.

Since the crane according to the invention is a crane for the installation of wind turbines, it can be operated for this purpose in a modular fashion with small transport volume and transport weight. This is evident if one considers that the installation of wind turbines requires large lifting heights, but involves only very small outreaches. Thus, relatively little ballast is needed for the crane work. The large quantity of ballast is needed for the erection of the long (lattice) boom. This is avoided here, and thus neither a derrick boom nor the large quantity of ballast needs to be transported to the construction site. The number of winches that need to be transported to the construction site could also be reduced, further reducing the transport volume and the transport weight. if the crane is used for other purposes, then a known crane design, as described in FIG. 25, can be used.

An additional advantage is the small space requirement at the time of the erection of the boom. On crests, or in case of installation of wind turbines in forest regions, little space is often available to set up the long lattice booms. Thus, a boom having a length of much more than 150 m can be set up only with difficulty, if at all.

Compared to conventional telescopic booms with stay systems, the present construction is very simple and robust.

In FIG. 27, the center of gravity SP of a lattice crane is drawn in diagrammatically; it is in a clearly higher position compared to the center of gravity SP′ of the telescopic boom according to the invention, which can be retracted by telescoping. One can clearly see that the telescopic. boom according to the invention provides improved safety against tipping, while having a comparable support width SB.

For transporting the crane to the construction site, segmentation into two transport units 700, 701 is provided, as shown in FIG. 28. The lower carriage 705 with rotating stage and stay rack travels as an automobile. The main boom 50 is taken off to remove load from the tires and axles.

The main boom 50 is deposited and transported on a semitrailer 710 with a trailer 712: The lift winch 52 can remain bolted to the boom base section 51, so that the cable of the lifting apparatus remains reeved in.

For travel on roads, the stay rack is separated from the upper carriage, and the upper carriage is also separated from the lower carriage 705. Thus, three transport units 700′, 701′, 702′ are prepared for the basic apparatus, as can be seen in FIG. 29.

The boom 50 is divided for travel on roads into at least two transport units 701′ and 702′. One transport unit is transported on a semitrailer 710′. Said semitrailer 710′ is also used for moving at the construction site or on the terrain. The base section 51, in which, for example, a telescopic shot can remain, is transported on a vehicle 720 with trailer 712′, wherein the system is similar to log trucks. The vehicle 720 itself is used. only for travel on public roads. The trailer 712′, however, is also used for moving at the construction site.

Because of the maximum admissible height, the lift winch 52 also has to be taken off during transport on public roads.

1. Boom element for a telescopic boom, particularly a telescopic shot or a telescopic boom base section, wherein the boom element has cupped corner pieces and lattice bars, and the cupped corner pieces are interconnected by the lattice bars, the lattice bars are arranged in a framework, at a right angle with respect to the corner pieces, and/or at an angle different from a right angle, particularly at an acute or obtuse angle, with respect to the corner pieces, and the corner pieces and the lattice bars form a substantially box-shaped hollow structure.

2. Boom element according to claim 1, wherein the corner pieces are have an edged and/or bent design and/or are manufactured from pipe sections and/or extruded sections.

3. Boom element according to claim 1, wherein the corner pieces present and/or form connecting pieces, and the lattice bars can be connected and/or joined to the connection pieces.

4. Boom element according to claim 1, wherein within the interior in the corner pieces one or more bearing seats are arranged, by which an additional boom element which is guided in the boom element can be guided and supported.

5. Boom element according to claim 1, wherein the boom element has an extension opening, out of which the additional boom element(s) located in the boom element can be extended, at the lower edge of the boom element, at least one bearing element is arranged, by which an additional boom element located in the boom element can be braced, and/or in the area of the extension opening, at least one abutment element is provided, by which the maximum extension movement of the additional boom element located in the boom element can be limited.

6. Boom element according to claim 5, wherein between at least one bearing seat and at least one bearing element, at least one spacer block is provided or arranged, by which the bearing seat and the bearing element can be pressed directly and/or indirectly, particularly at the time of the complete extension of an additional boom element located in the boom element, the bearing seat and the bearing element are pressed against each other, and it is preferred the spacer block is reinforced with at least one reinforcement core, particularly a steel core.

7. Boom element according to claim 1, wherein at least one component of a bolting system is arranged in at least one of the corner pieces, by said bolting system an additional boom element located in the boom element can be bolted to be secured to the boom element, the component of the bolting system is and/or comprises at least one bolt receiver and/or at least one bolt guide in which the at least one bolt is guided and movable, the bolt receiver can preferably have a reinforced bolting metal plate which is inserted and/or engaged in the corner piece, and, moreover, at least one bolting system is arranged in three or four corner pieces.

8. Boom element according to claim 1, wherein the corner pieces, which are in a low position in the installed state, protrude over the end cross section of the hollow structure, particularly over the extension opening.

9. Telescopic boom having at least one boom element according to claim 1.

10. Construction vehicle, in particular mobile crane with telescopic boom, having at least one boom element according to claim 1 and/or having at least one telescopic boom.

11. Boom element according to claim 2, wherein the corner pieces present and/or form connecting pieces, and the lattice bars can be connected and/or joined to the connection pieces.

12. Boom element according to claim 11, wherein within the interior in the corner pieces one or more bearing seats are arranged, by which an additional boom element which is guided in the boom element can be guided and supported.

13. Boom element according to claim 3, wherein within the interior in the corner pieces one or more bearing seats are arranged, by which an additional boom element which is guided in the boom element can be guided and supported.

14. Boom element according to claim 2, wherein within the interior in the corner pieces one or more bearing seats are arranged, by which an additional boom element which is guided in the boom element can be guided and supported.

15. Boom element according to claim 14, wherein the boom element has an extension opening, out of which the additional boom element(s) located in the boom element can be extended, at the lower edge of the boom element, at least one bearing element is arranged, by which an additional boom element located in the boom element can be braced; and/or in the area of the extension opening, at least one abutment element is provided, by which the maximum extension movement of the additional boom element located in the boom element can be limited.

16. Boom element according to claim 13, wherein the boom element has an extension opening, out of which the additional boom element(s) located in the boom element can be extended, at the lower edge of the boom element, at least one bearing element is arranged, by which an additional boom element located in the boom element can be braced, and/or in the area of the extension opening, at least one abutment element is provided, by which the maximum extension movement of the additional boom element located in the boom element can be limited.

17. Boom element according to claim 12, wherein the boom element has an extension opening, out of which the additional boom element(s) located in the boom element can be extended, at the lower edge of the boom element, at least one bearing element is arranged, by which an additional boom element located in the boom element can be braced, and/or in the area of the extension opening, at least one abutment element is provided, by which the maximum extension movement of the additional boom element located in the boom element can be limited.

18. Boom element according to claim 11, wherein the boom element has an extension opening, out of which the additional boom element(s) located in the boom element can be extended, at the lower edge of the boom element, at least one bearing element is arranged, by which an additional boom element located in the boom element can be braced, and/or in the area of the extension opening, at least one abutment element is provided, by which the maximum extension movement of the additional boom element located in the boom element can be limited.

19. Boom element according to claim 4, wherein the boom element has an extension opening, out of which the additional boom element(s) located in the boom element can be extended, at the lower edge of the boom element, at least one bearing element is arranged, by which an additional boom element located in the boom element can be braced, and/or in the area of the extension opening, at least one abutment element is provided, by which the maximum extension movement of the additional boom element located in the boom element can be limited.

20. Boom element according to claim 3, wherein the boom element has an extension opening, out of which the additional boom element(s) located in the boom element can be extended, at the lower edge of the boom element, at least one bearing element is arranged, by which an additional boom element located in the boom element can be braced, and/or in the area of the extension opening, at least one abutment element is provided, by which the maximum extension movement of the additional boom element located in the boom element can be limited.
